(19) United States
(12) Patent Application Publication
(10) Pub. No.: US 2018/0372908 A1
(43) Pub. Date: Dec. 27, 2018

(54) DIP-EFFECT CORRECTION OF MULTICOMPONENT LOGGING DATA

(71) Applicant: Halliburton Energy Services, Inc., Houston, TX (US)

(72) Inventor: Junsheng Hou, Kingwood, TX (US)

(21) Appl. No.: 16/063,167

(22) PCT Filed: Mar. 10, 2016
(86) PCT No.: PCT/US2016/021681

§ 371 Date: Jun. 15, 2018

(51) Int. Cl. G01V 3/38; G01V 3/28; E21B 47/026; G01V 99/00; E21B 47/12

(52) U.S. Cl. CPC G01V 3/38; G01V 3/28; E21B 47/122; G01V 99/005; E21B 47/026

(57) ABSTRACT

Methods and a system are described, such as for correcting multicomponent logging data. The method measures geological formation resistivity to generate formation resistivity data. Borehole correction (BHC) is performed on the formation resistivity data to remove a borehole effect and generate BHC log data. A forward model is selected from a plurality of forward models based on the formation resistivity data. A dip-effect on the BHC log data is determined based on the selected forward model. The dip-effect is removed from the BHC log data to generate dip-effect corrected BHC log data.

### BACKGROUND

Various types of fractures (natural or drilling induced; open or closed) commonly occur in subsurface formations. Hence, fracture detection and characterization play an important role in fractured reservoir evaluation since different types of fractures are able to provide additional pathways to oil/gas flow. Fracture detection may also provide important information for optimizing well production and fracturing design if needed.

The presence of fractures filled with varied types of fluid may change the physical parameter distribution of a formation such as resistivity and velocity around wellbores. Therefore, different types of open/cased hole logging methods have been used for this purpose.

Multicomponent induction (MCI) logging has been developed for evaluation of various types of anisotropic formations (e.g., laminated shale-sand and low-resistivity reservoirs) by means of determined resistivity anisotropy (horizontal and vertical resistivities), dip, and dip azimuth. However, dip effects may induce errors during fracture detection using MCI.

### BRIEF DESCRIPTION OF THE DRAWINGS

FIG. 1 is a diagram showing a multi-triaxial induction sensor tool, according to various examples of the disclosure.

FIG. 2 is a cross-sectional diagram showing the multi-triaxial induction sensor tool in a borehole of a formation with multiple resistivity regions, according to various examples of the disclosure.

FIG. 3 are plots of MCI logging components XX and YY and their differences for four triaxial arrays at 36 kilohertz (kHz) in a transversely isotropic formation, according to various examples of the disclosure.

FIG. 4 are plots of MCI logging components XX and YY and their differences for four triaxial arrays at 60 kilohertz (kHz) in a transversely isotropic formation, according to various examples of the disclosure.

FIG. 5 are plots of MCI logging components XX and YY and their differences for four triaxial arrays at 36 kilohertz (kHz) in a biaxial anisotropic formation, according to various examples of the disclosure.

FIG. 6 are plots of MCI logging components XX and YY and their differences for four triaxial arrays at 60 kilohertz (kHz) in a biaxial anisotropic formation, according to various examples of the disclosure.

FIG. 7 are plots of simulated MCI logging components XX, YY, XX-YY, and ZZ of a 17-inch triaxial array in a biaxial anisotropic formation with a boundary layer dip angle of 50°, according to various examples of the disclosure.

FIG. 8 are plots of simulated MCI logging components XX. YY, XX-YY, and ZZ of the 17-inch triaxial array in a biaxial anisotropic formation with a boundary layer dip angle of 0°, according to various examples of the disclosure.

FIG. 9 is a plot of conventional R90, R60, R30, R20, and R10 logs without dip-effect correction, according to various examples of the disclosure.

FIG. 10 is a plot of R90, R60, R30, R20, and R10 logs with dip-effect correction, according to various examples of the disclosure.

FIG. 11 is a flowchart of a method for dip-effect correction of MCI logging components, according to various examples of the disclosure.

FIG. 12 is a flowchart of a workflow MCI logging component processing method incorporating the example of FIG. 11, according to various examples of the disclosure.

FIG. 13 is a diagram of a drilling system, according to various examples of the disclosure.

FIG. 14 is a diagram of a wireline system, according to various examples of the disclosure.

FIG. 15 is a block diagram of an example system operable to implement the activities of multiple methods, according to various aspects of the present disclosure.

### DETAILED DESCRIPTION

To address some of the challenges described above, as well as others, a method for boundary layer dip angle effect (dip-effect) correction of MCI logging data (e.g., MCI logging components) may be used for enhancement of integrated fracture identification in a geological formation.

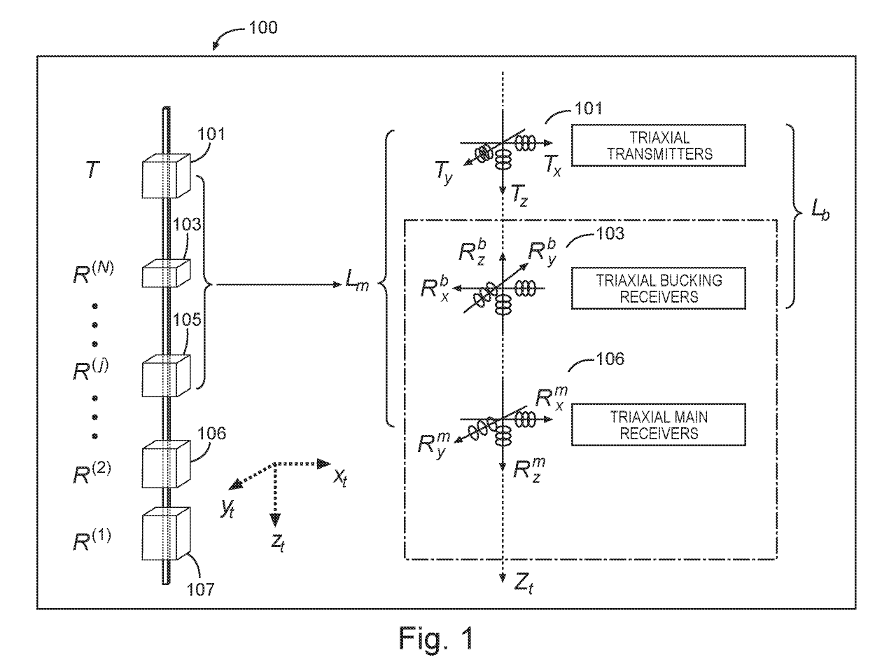

FIG. 1 is a diagram showing a multi-triaxial induction sensor tool 100, according to various examples of the disclosure. The multi-triaxial induction sensor tool of FIG. 1 is for purposes of illustration only. Other sensor tools may be used with the following examples to achieve substantially similar or the same results.

The illustrated tool 100 includes a transmitter 101, at least one bucking receiver 103, and at least one main receiver 103-107. In an example, the transmitter 101 and receivers 103-107 are distributed along the axis of the tool 100. Since each transmitter 101 and receiver 103-107 comprises a respective plurality of coils, the transmitter 101 is commonly referred to as a transmitter array 101 and each receiver 103-107 is commonly referred to as a receiver array 103-107.

The transmitter 101 may be a triaxial transmitter having transmitter coils Tₓ, T_{y}, and T_{z} aligned along their respective x, y, and z axes. The bucking receiver 103 includes mutually orthogonal collocated receiver coils Rₓ, R_{y}, and R_{z} that are each wound to have an opposite polarity to the respective transmitter coils Tₓ, T_{y}, and T_{z}. This enables the bucking receiver 103 to be insensitive to the direct transmission of the electromagnetic (EM) signals from the transmitter 101 and, thus, shield the main receivers 105-107 from being affected by the direct signal from the transmitter 101.

The main receivers 105-107 may be triaxial receivers having mutually orthogonal collocated receiver coils Rₓ^{m}, R_{y}^{m}, and R_{z}^{m} aligned along their respective x, y, and z axes. The receiver coils of the main receivers 105-107 are wound with the same polarity as the transmitter coils Tₓ, T_{y}, and T_{z} such that they are able to receive the EM signals back from the geological formation have the same polarity as the respective transmitted EM signal.

Voltages that are measured on all of the receivers 103-107 are calibrated into apparent conductivities. In general, all nine apparent conductivity components may be expressed as a 3-by-3 tensor or matrix for the multi-array triaxial induction tool operated at multiple frequencies:

$$\overline{\overline{{σ}_{a}^{( i , j )}}} = ( \begin{matrix}{σ}_{xx}^{( i , j )} & {σ}_{xy}^{( i , j )} & {σ}_{xz}^{( i , j )} \\ {σ}_{yx}^{( i , j )} & {σ}_{yy}^{( i , j )} & {σ}_{yz}^{( i , j )} \\ {σ}_{zx}^{( i , j )} & {σ}_{zy}^{( i , j )} & {σ}_{zz}^{( i , j )}\end{matrix} ) = {( {σ}_{IJ}^{( i , j )} )}_{( 3 \times 3 )} \qquad ( 1 )$$

The multi-array triaxial induction sensor 100 may be considered to include N triaxial subarrays (i.e., TR⁽¹⁾, TR⁽²⁾, . . . , and TR^{(N)}, or further denoted as A1, A2, . . . , and AN). Lₘ is the transmitter-receiver spacing for the main receivers. La is the transmitter-receiver spacing of the bucking receivers and (xₜ, yₜ, zₜ) is the three-dimensional (3D) tool/measurement coordinate system used subsequently.

The various voltage measurements (e.g., component measurements) made by each of the receivers 103-107 may be identified by the particular one of the coils that was energized at the transmitter and the particular one of the coils at each receiver 103-107 for which a corresponding voltage is detected. Thus, for each receiver 103-107, there are nine component measurements: a detected voltage for each of the Rₓ^{m}, R_{y}^{m}, and R_{z}^{m} receiver coils corresponding to energizing of each of the Tₓ, T_{y} and T_{z} transmitter coils. In the explanation below, each component measurement is identified by a letter pair corresponding to the particular transmitter coil and the particular receiver coil. The nine component measurements are thus identifiable by MCI logging component references XX, XY, XZ, YX, YY, YZ, ZX, ZY, ZZ. Component measurements that use the same transmitter and receiver dipole moment directions (e.g., XX, YY, ZZ) are typically referred to as “direct coupled” component measurements. Component measurements that use a different transmitter dipole moment than the one used for the receiver (e.g., XY, XZ, YX, YZ, ZX, ZY) are typically referred to as “cross-component” or “cross-coupled” measurements.

Using the above. Equation (1) may be written as:

$$\overline{\overline{{σ}_{a}^{( i , j )}}} = ( \begin{matrix}{XX}^{( i , j )} & {XY}^{( i , j )} & {XZ}^{( i , j )} \\ {YX}^{( i , j )} & {YY}^{( i , j )} & {YZ}^{( i , j )} \\ {ZX}^{( i , j )} & {ZY}^{( i , j )} & {ZZ}^{( i , j )}\end{matrix} ) = {( {IJ}^{( i , j )} )}_{( 3 \times 3 )} \qquad ( 2 )$$

where I,J=x/X,y/Y,z/Z, i=1, 2, . . . , N, j=1, 2, . . . , M, σ̅ₐ̅^̅{̅(̅i̅,̅j̅)̅}̅ is referred to as the MCI apparent conductivity tensor (R- or X-signal) in the 3D tool coordinate system, σ_{IJ}^{(i,j)} or IJ^{(i,j)} are the measured-conductivity couplings of σ̅ₐ̅^̅{̅(̅i̅,̅j̅)̅}̅, where the first subscript, I, indicates the transmitter direction and the second subscript, J, indicates the receiver direction. Consequently, for example, when I, J=x/X, σ_{IJ}^{(i,j)} is σₓₓ^{(i,j)} (or XX^{(i,j)}), when I, J=y or Y, σ_{IJ}^{(i,j)} is σ_{yy}^{(i,j)} (or YY^{(i,j)}), and when I, J=z/Z, σ_{IJ}^{(i,j)} is σ_{zz}^{(i,j)} (or ZZ^{(i,j)}), in which σ_{zz}^{(i,j)} are the traditional multi-array induction measurements, N is the total number of the triaxial subarrays, and M is the total number of the operating frequencies. Hence, the 2*9*M*N R-signal and X-signal data for every log point should be available. Therefore, the MCI nine component measurements at multiple arrays and frequencies can be determined using this MCI tool. Compared to conventional resistivity tools, different component measurements may be used for solving anisotropic formation evaluation and integrated fracture characterization with multiple measurements.

From the above, one conductivity component σ_{IJ}^{(i,j)} or IJ^{(i,j)} of a tensor conductivity may be expressed further as:

σ_{IJ}^{(i,j)}=k_{IJ}^{(i,j)}·H_{IJ}^{(i,j)}, (3)

where k_{IJ}^{(i,j)} is the calibration factor for conversion from magnetic field (or inductive voltage) to apparent conductivity, and H_{IJ}^{(i,j)} is the measured magnetic field (or inductive voltage).

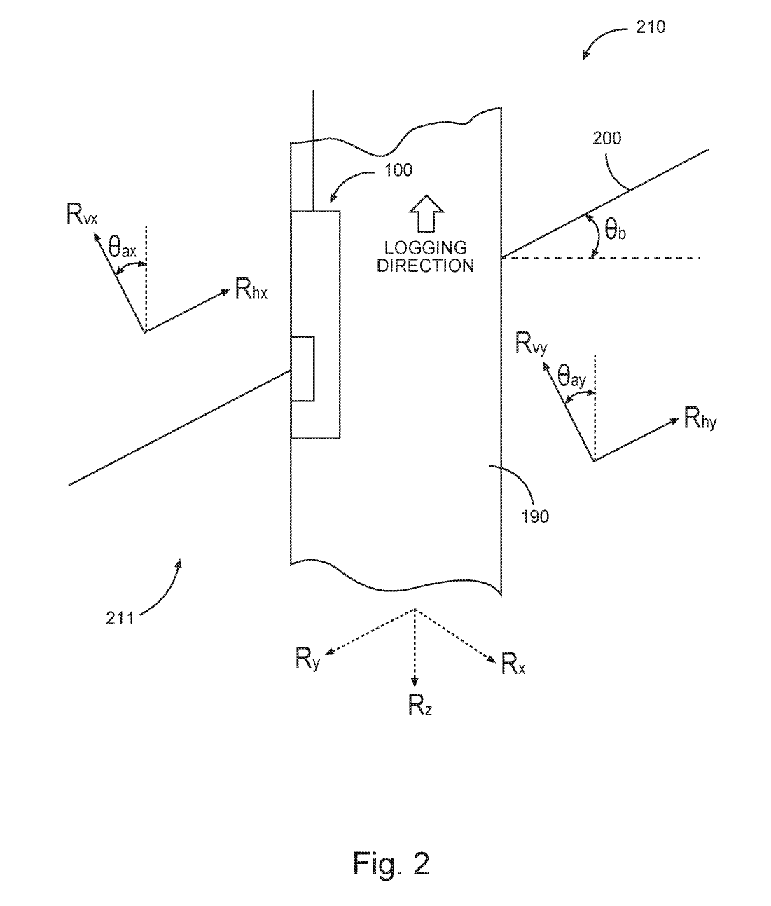

FIG. 2 is a cross-sectional diagram showing the multi-triaxial induction sensor tool 100 in a borehole of a formation with multiple resistivity regions 210, 211, according to various examples of the disclosure. The imaging tool 140 may include one or more button electrode structures 100 as discussed previously.

For simplicity, it is assumed that the formation includes only two different resistivity regions 210, 211 (i.e., formation layers). The examples included herein may be extended to additional formation layers.

Adjacent resistivity regions 210, 211 are separated by a boundary 200. The angle of this boundary 200 relative to a horizontal reference may be referred to as the formation layer boundary dip angle or simply dip and is denoted as θ_{b}. There may be an azimuthal offset angle of the dip angle with respect to a reference point on the tool 100.

The resistivity of the first region 210 is represented by horizontal resistivity Rₕ₁ and vertical resistivity Rᵥ₁. The resistivity of the second region 211 is represented by horizontal resistivity Rₕ₂ and vertical resistivity Rᵥ₂. The anisotropy dip angle for the first region 210 is then represented by θₐ₁ and the anisotropy dip angle for the second region 211 is represented by θₐ₂. The azimuthal offset angle of the dip angle with respect to a reference point on the tool 100 is represented by ϕ_{b}.

As described previously, the logging tool 100 makes measurements of the formation resistivity along the various axes of the transmitter and receiver coils. These measurements will be referred to subsequently as resistivity components of the formation: Ry for the resistivity measured along the y-axis, Rx for the resistivity measured along the x-axis, and Rz for the resistivity measured along the z-axis in a formation principal 3D coordinate system. Here Rx, Ry, and Rz are in the formation principal 3D coordinate system, where it is generally different from the tool coordinate system described previously.

The real earth model is described by 3D models. To understand the effects of formation properties, such as formation dip, on the conductivity components σ_{IJ}^{(i,j)} or IJ^{(i,j)}, formation models such as radially one-dimensional (R1D) model, Zero dimensional (0D) model, and vertically one-dimensional (V1D) isotropic model may be considered and then used for real data processing (e.g., dip correction) and integrated interpretation.

The RID model is initially considered. In the RID model, that includes a borehole and a zero-dimensional (0D) BA resistivity-anisotropic formation, the measured H_{IJ}^{(i,j)} can be expressed as a complicated complex function:

H_{IJ}^{(i,j)}=F_{IJ}^{(i,j)}(frequency,L,BD,Rm,ecc,eccAng,Rx,Ry,Rz,dip) (4)

where F_{IJ}^{(i,j)} is a function of variables tool frequency (e.g., frequency=12 k, 36 k, 60 k, 84 kHz), tool array spacing L (e.g., 17, 29, 50, 80-in), borehole size (BD), mud resistivity (Rm), tool eccentricity (ecc), tool eccentricity angle (eccAng), formation triaxial resistivity components Rx, Ry, Rz, and boundary layer dip angle. In Equation (4), there is no analytical solution for F_{IJ}^{(i,j)} so the numerical methods for obtaining F_{IJ}^{(i,j)} are used. These may include three-dimensional finite difference (3DFD) or finite element (FE).

In a zero-dimensional BA resistivity-anisotropic formation without a borehole (e.g., after the so-called borehole effect correction), H_{IJ}^{(i,j)} may be reduced as a function F_{IJ}^{(i,j)}(frequency,L,Rx,Ry,Rz,dip) of only six variables of tool frequency, array spacing L, triaxial resistivity components Rx, Ry, Rz. and dip:

H_{IJ}^{(i,j)}=F_{IJ}^{(i,j)}(frequency,L,Rx,Ry,Rz,dip). (5)

In this case, a semi-analytical solution is obtained for function F_{IJ}^{(i,j)}(frequency,L,Rx,Ry,Rz,dip) or σ_{IJ}^{(i,j)}.

As the two special cases for Equation (5), at first we have the reduced equation for a zero dimensional TI resistivity-anisotropic formation:

H_{IJ}^{(i,j)}=F_{IJ}^{(i,j)}(frequency,L,Rh,Rv,dip). (6)

where Rh and Rv denote the formation horizontal and vertical resistivity, and Rh=Rx=Ry, Rv=Rz. In this case, we have an analytical solution for function F_{IJ}^{(i,j)}(frequency,L,Rh,Rv,dip) or σ_{IJ}^{(i,j)}.

A reduced equation for a zero dimensional resistivity-isotropic formation may be expressed as:

H_{IJ}^{(i,j)}=F_{IJ}^{(i,j)}(frequency,L,Rt,dip). (7)

where Rt denotes the true formation resistivity, and Rt=Rx=Ry=Rz. In this case, an analytical solution for function may be expressed as F_{IJ}^{(i,j)}(frequency, L, Rt, dip) or σ_{IJ}^{(i,j)}.

In a so-called V1D formation model with BA anisotropy, the equation for determination of the apparent conductivity component may be expressed by:

σ_{IJ}^{(i,j)}=k_{IJ}^{(i,j)}·H_{IJ}^{(i,j)}(frequency,L,Rx(z),Ry(z),Rz(z),dip(z)). (8)

where all three true resistivity components and relative dip angle are a function of depth z and they can be expressed as a piece-wise constant function of layer resistivity, boxcar function, and depth z, namely one of:

$$Rx ( z ) = {\sum }_{k = 1}^{Nlayer} {Rx}^{( k )} \cdot \prod ( z , {z}_{k} , {z}_{k + 1} ) , \\ Ry ( z ) = {\sum }_{k = 1}^{Nlayer} {Ry}^{( k )} \cdot \prod ( z , {z}_{k} , {z}_{k + 1} ) , \\ Rz ( z ) = {\sum }_{k = 1}^{Nlayer} {Rz}^{( k )} \cdot \prod ( z , {z}_{k} , {z}_{k + 1} ) , or$$

$${R}_{t} ( z ) = {\sum }_{k = 1}^{Nlayer} {R}_{t}^{( k )} \cdot \prod ( z , {z}_{k} , {z}_{k + 1} ) , and$$

$$dip ( z ) = {\sum }_{k = 1}^{Nlayer} {dip}^{( k )} \cdot \prod ( z , {z}_{k} , {z}_{k + 1} ) .$$

It is assumed that the V1D-BA formation is an N layer-bed formation, where N is the total number of the beds, Rx^{(k)}, Ry^{(k)}, Rz^{(k)}, and dip^{(k)} are triaxial resistivities and dip of the k^{th} layer, and Π(z, zₖ, zₖ₊₁) is a boxcar function and that can be expressed as Π(z, zₖ, zₖ₊₁)=H(z−zₖ)−H(z−zₖ₊₁). Here H(z−zₖ) and H(z−zₖ₊₁) are the two Heaviside step functions (or unit step functions).

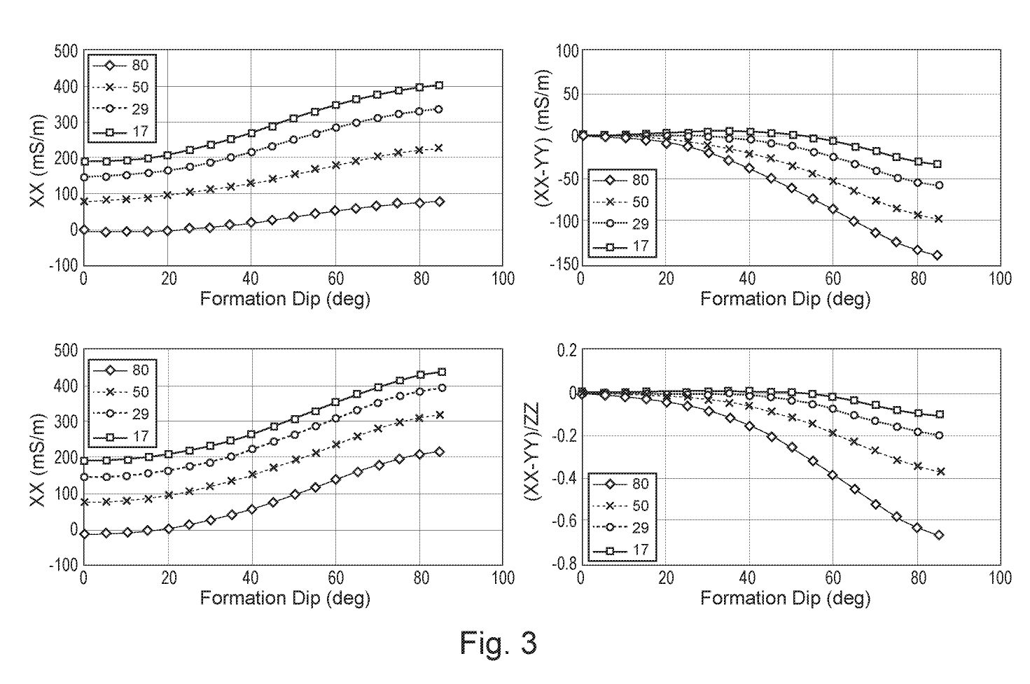

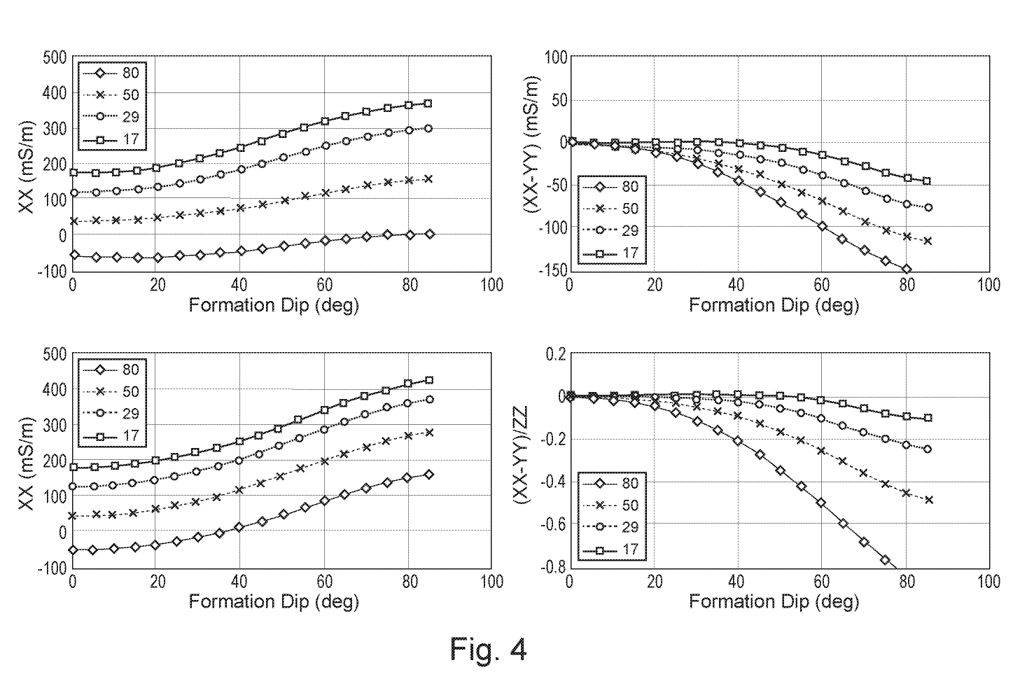

FIG. 3 are plots of MCI logging components XX and YY and their differences for four tiaxial arrays at 36 kilohertz (kHz) in a transversely isotropic formation, according to various examples of the disclosure. FIG. 4 are plots of MCI logging data components XX and YY and their differences for four tiaxial arrays at 60 kilohertz (kHz) in a transversely isotropic formation, according to various examples of the disclosure.

In TI-anisotropy formations, it is typically assumed that there is no fracture but it can be observed that there is no difference between XX and YY in a vertical well (or dip=00) in FIGS. 3 and 4. Due to the different behaviors for XX and YY at different dip values, the significant differences of XX and YY are observed if the dip is not zero. We also see the contribution to the differences (XX-YY) from different arrays and frequencies by comparisons. But FIGS. 3 and 4 also show that the effects from dip, tool frequency and spacing are minimized at the zero degree dip angle. Thus, the dip-effect correction may be used to reduce all three effects on the difference (XX-YY).

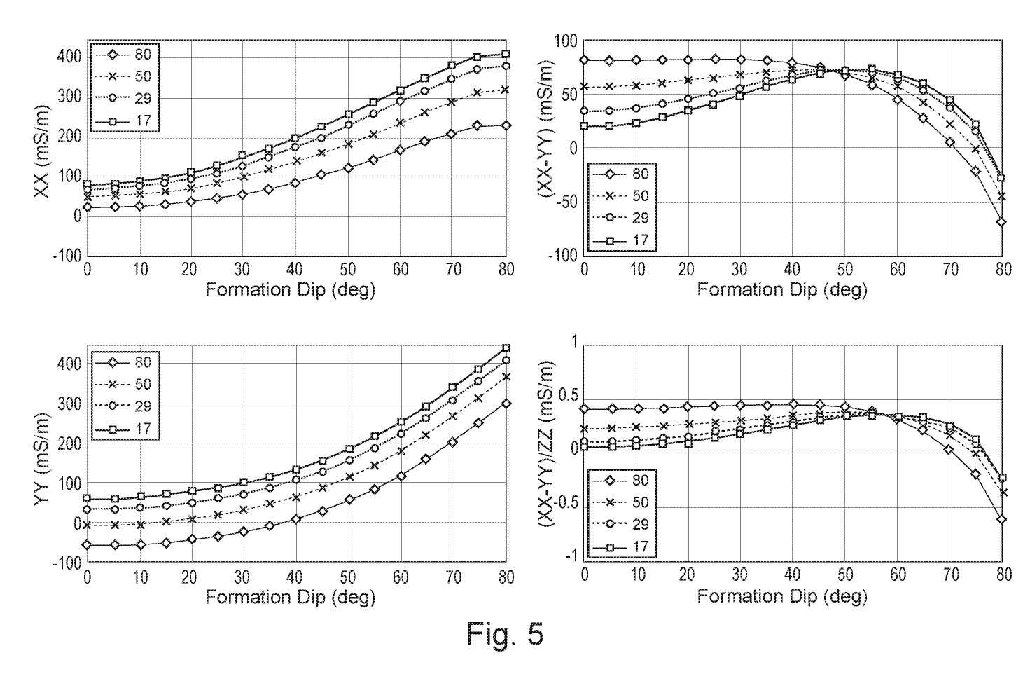

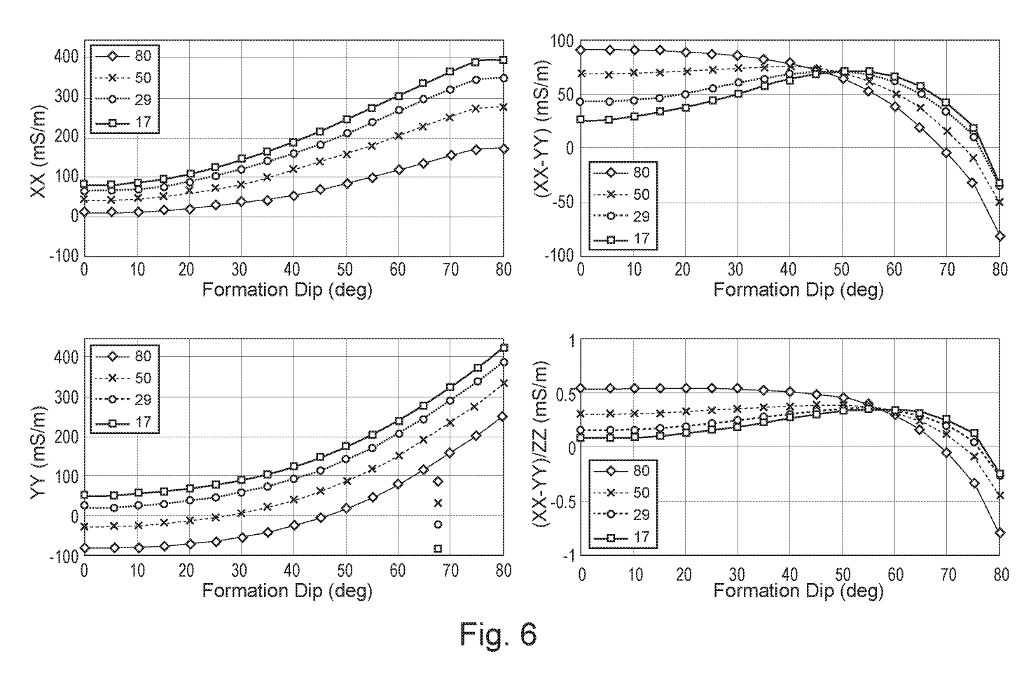

FIG. 5 are plots of MCI logging components XX and YY and their differences for four tiaxial arrays at 36 kilohertz (kHz) in a biaxial anisotropic formation, according to various examples of the disclosure. FIG. 6 are plots of MCI logging data components XX and YY and their differences for four tiaxial arrays at 60 kilohertz (kHz) in a biaxial anisotropic formation, according to various examples of the disclosure. In BA-anisotropy formations, the difference between XX and YY may be seen in vertical and dipping wells. FIGS. 5 and 6 present the simulated MCI components XX and YY, and their differences (XX-YY) and (XX-YY)/ZZ for 4 triaxial arrays at two frequencies of 36 kHz and 60 kHz vs different dips in a zero dimension BA formation model. Compared to the plots of FIGS. 3 and 4, the differences (XX-YY) are observed in the BA formation. Even at a zero-degree dip angle, the (XX-YY) is not zero due to an XX and YY difference to azimuthal sensitivity in the bedding plane. But in high dip cases, the XX and YY differences may be reduced by performing the dip-effect correction for reducing the uncertainty from the dip effects.

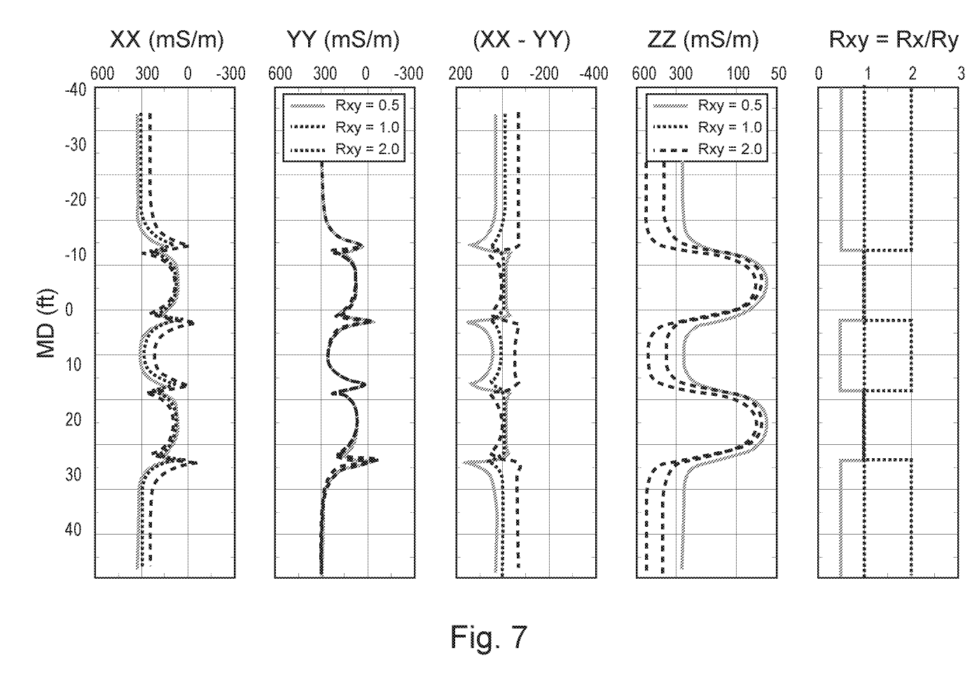

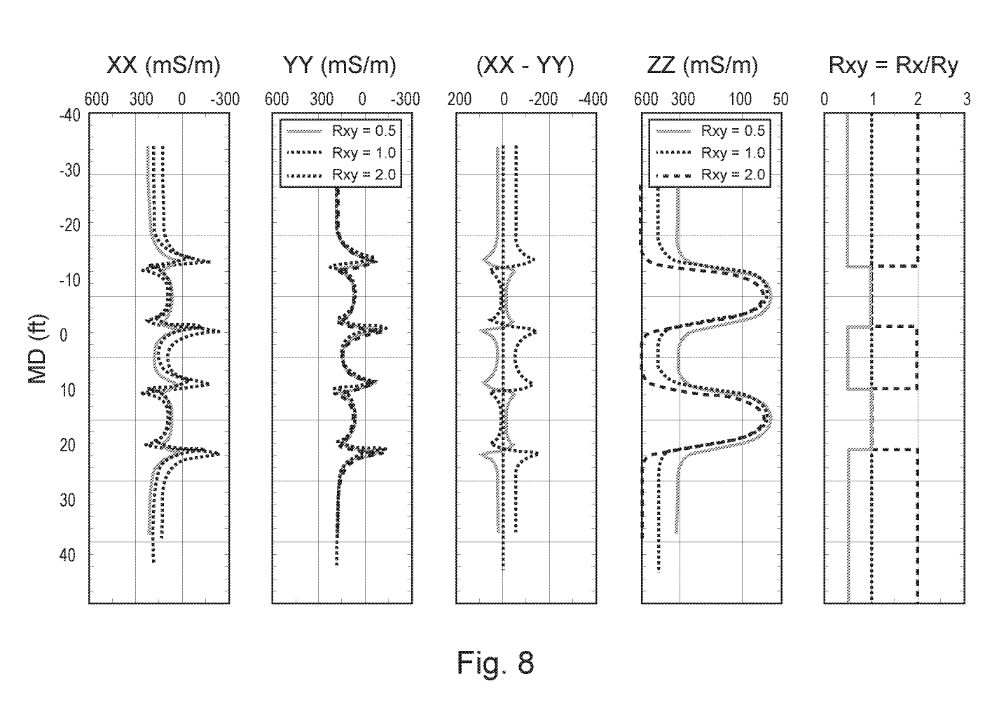

FIG. 7 are plots of simulated MCI logging components XX, YY, XX-YY, and ZZ of a 17-inch triaxial array in a biaxial anisotropic formation with a boundary layer dip angle of 50°, according to various examples of the disclosure. FIG. 8 are plots of simulated MCI logging components XX, YY, XX-YY, and ZZ of the 17-inch triaxial array in a biaxial anisotropic formation with a boundary layer dip angle of 0°, according to various examples of the disclosure. FIGS. 7 and 8 show simulated XX, YY, XX-YY, and ZZ assuming a 17-in sensor array in a 5-bed V1D-BA formation at two dip angles of 50° and 0° for three cases of Rxy=0.5, 1, and 2.0. In each figure, XX log is on track 1 (left-most), YY is on track 2, XX-YY is on track 3, ZZ is on track 4, and Rxy is on track 5 (right). The comparison clearly shows that the XX-YY in the vertical well indicates the more accurate information for detecting the BA zones (or fracture zones). In addition, the XX, YY, and ZZ logs can be used as an indicator of lithology.

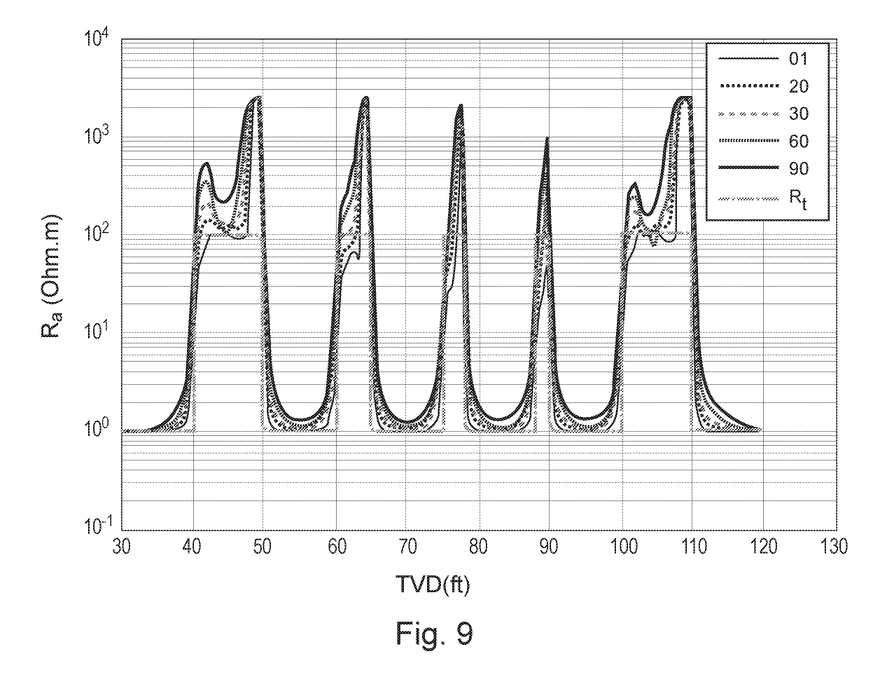

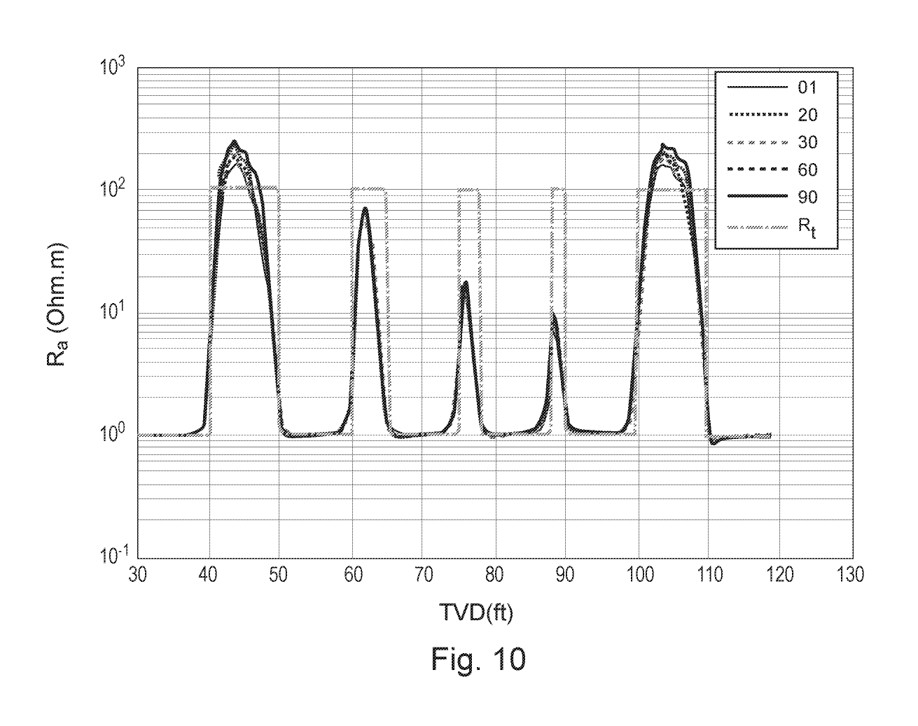

FIG. 9 is a plot of conventional R90, R60, R30, R20, and R10 logs without dip-effect correction, according to various examples of the disclosure. FIG. 10 is a plot of R90, R60, R30, R20, and R10 logs with dip-effect correction, according to various examples of the disclosure. In general, there is no obvious separation among the conventional resistivity logs (e.g., R90 and R10 logs) in OBM wells. Otherwise, it would be suspected that this separation is caused by fractures. From the modeling, it is known that the dip effect can contribute to the false conventional log separation as shown in FIGS. 9-10. The above-described conventional logs would thus benefit from method for dip-effect correction for fractures.

For the dip-effect correction of MCI borehole corrected (BHC) logs in both TI and BA anisotropic formations, the following equation is used for the correction:

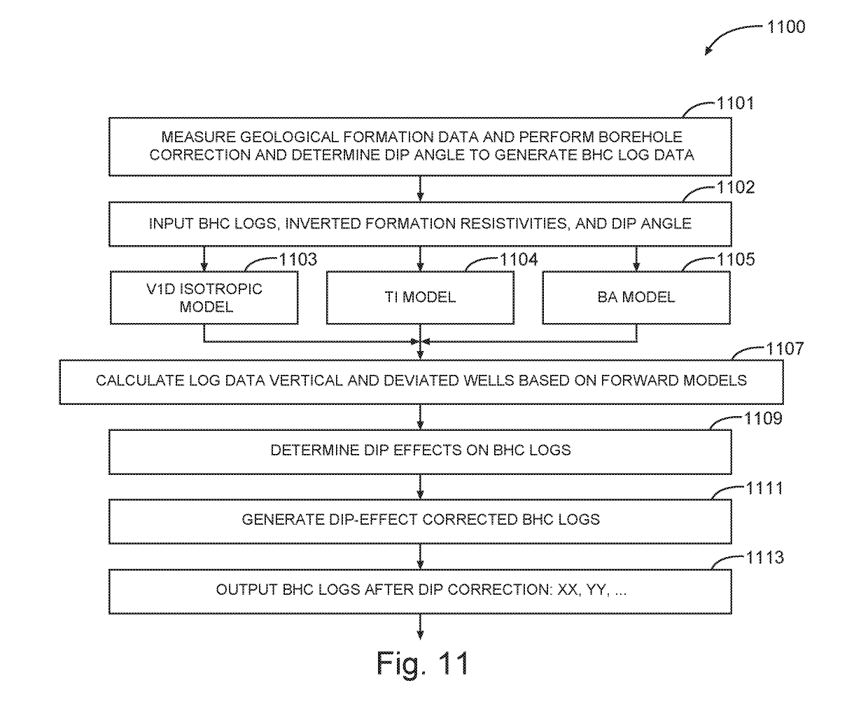

BHC^{(dec)}(z)=BHC(z)+α(z)·[x(dip=0,z)−x(dip,z)], (9)

where BHC^{(dec)} is the apparent conductivity of the dip-effect corrected MCI component, BHC(z) is one of the MCI components after the borehole correction, x(dip=0, z) is the computed component in a zero dimension or V1D TUBA formation at a 0° dip angle and x(dip, z) is the correspondent in a zero dimension or V1D TI/BA formation at a non-zero dip angle, and α(z) is a coefficient for adjusting the shoulder effect. For example, α(z)=1 in a true zero dimension formation. An example workflow for the dip-effect correction is shown in FIG. 11 and described subsequently.

For example, we have the equations for dip-effect correction of XX, YY, and ZZ components:

XX^{(dec)}(z)=XX_{BHC}(z)+α(z)·[XX(dip=0,z)−XX(dip,z)] (10)

YY^{(dec)}(z)=YY_{BHC}(z)+α(z)·[YY(dip=0,z)−YY(dip,z)] (11)

ZZ^{(dec)}(z)=ZZ_{BHC}(z)+α(z)·[ZZ(dip=0,z)−ZZ(dip,z)] (12)

If it is assumed that the formation dip angle and measured triaxial resistivities (Rx, Ry, Rz) are known based on the zero dimensional model, then the dip-effect correction may be determined as follows using Equation (7):

x(dip=0,z)−x(dip,z)=k_{IJ}^{(i,j)}·[H_{IJ}^{(i,j)}(frequency,L,Rx,Ry,Rz,dip=0)−H_{IJ}^{(i,j)}(frequency,L,Rx,Ry,Rz,dip)]. (13)

FIG. 11 is a flowchart of a method for dip-effect correction of MCI logging components, according to various examples of the disclosure. The method 1100 begins in block 1101 with the measurement of geological formation resistivity to generate formation resistivity data and performing borehole correction of the formation resistivity data to remove the borehole effect and generate the MCI BHC log data. The measured data is also used to determine the formation layer boundary dip angle.

The geological formation resistivity that generates the formation resistivity data may be measured using the multi-triaxial induction sensor tool as shown in FIG. 1 or by some other logging sensors. The formation resistivity data may include, for example, parameters discussed previously with respect to FIGS. 1 and 2 such as vertical and horizontal resistivities for each region as well as the anisotropy dip angles for each region. For example, the formation resistivity data may be acquired by transmitting electromagnetic signals from the triaxial transmitter having coils aligned along x, y, and z axes, receiving electromagnetic signals from the geological formation in response to the transmitted electromagnetic signals, wherein the triaxial receiver is configured to receive the electromagnetic signals along the x, y, or z axes, and determining the formation resistivity data in response to the received electromagnetic signals wherein Rx represents the resistivity along the x-axis, Ry represents the resistivity along the y-axis, and Rz represents the resistivity along the z-axis in the formation principal coordinate system.

In block 1102, the MCI BHC logs, the inverted formation resistivities, and the formation layer boundary dip angle are input to one of a plurality of different forward models 1103-1105. For example, the models may include the V1D isotropic model 1103, the TI model 1104, and/or the BA model 1105. Other embodiments may use different forward models.

The forward model 1103-1105 used in the subsequent calculations is chosen based on the formation resistivity data from block 1101. For example, if Rₓ=R_{y}=R_{z} (i.e., resistivity is the same in all directions of measurement), then the V1D isotropic model 1103 is used. If Rₓ=R_{y}≠R_{z} (i.e., resistivity is the same around tool but different below the tool), then the transversely isotropic (TI) model 1104 is used. If Rₓ≠R_{y}≠R_{z} (i.e., resistivity is different in all directions), then the biaxial anisotropic (BA) model 1105 is used.

In block 1107, the BHC log data for vertical and deviated (i.e., non-vertical) wells are determined based on the chosen forward model 1103-1105. This may be accomplished by using Equation (9) above. In that equation, the second term (α(z)·[x(dip=0, z)−x(dip, z)]) is the calculated borehole effect. In the second term, x(dip=0, z) represents log data at a vertical well and x(dip, z) represents log data at a deviated well having a dip effect.

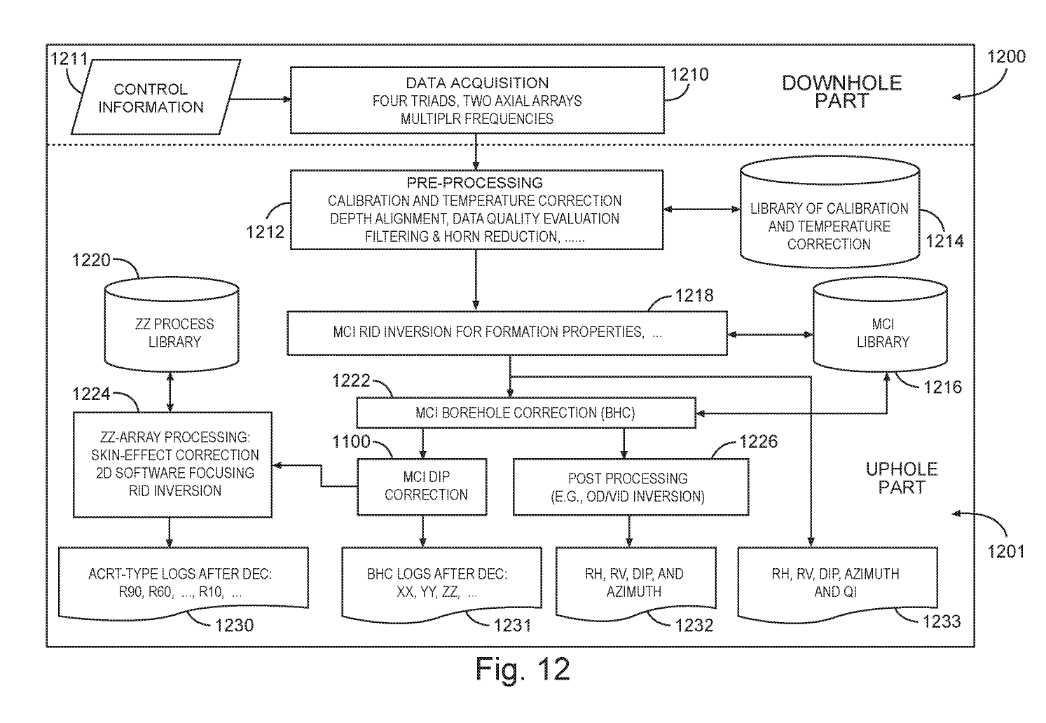

In block 1109, the dip effects on the BHC log data are determined based on the selected forward model, as shown in Equations 10-12. In block 1111, the dip-effect corrected BHC log data are calculated as shown in Equation (13) by removing (i.e., subtracting) the dip-effect from the BHC log data. This may be accomplished by subtracting the log data with the dip-effect (e.g., from the deviated well) from the log data without the dip-effect (e.g., from the vertical well). Block 1113 outputs these corrected log data to be used as shown in the workflow of FIG. 12.

The determination of formation anisotropy and boundary layer dip angle are based on different forward models. From the subsequent workflow of FIG. 12, the dip-effect corrected log data may be used to obtain array compensated resistivity tool logs, BHC logs, and the formation horizontal and vertical resistivities (i.e., Rₕ and Rᵥ, respectively), boundary layer dip angle, and dip azimuth.

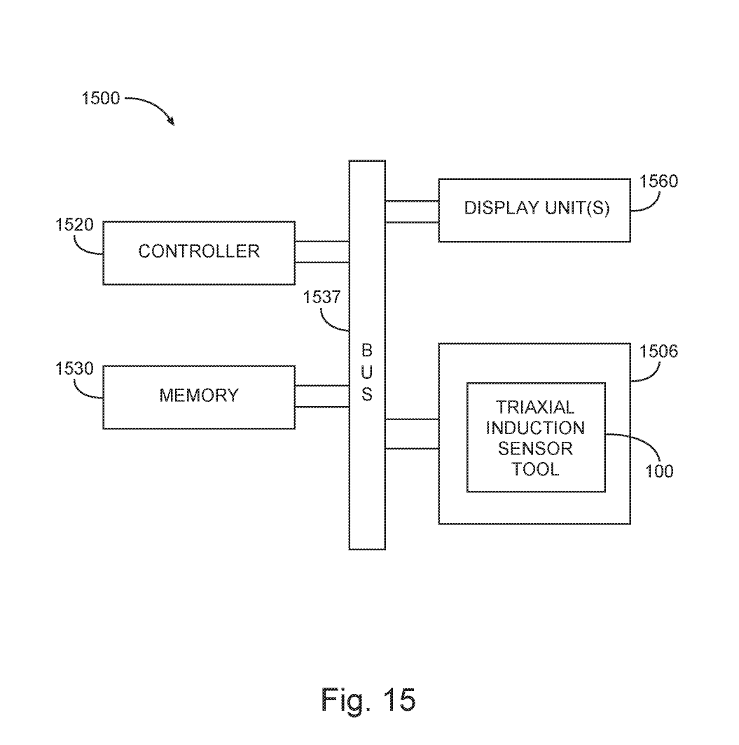

FIG. 12 is a flowchart of a workflow MCI logging component processing method incorporating the example of FIG. 11, according to various examples of the disclosure. The workflow of FIG. 12 is shown divided up into a downhole part 1200, performed by a downhole tool (e.g., 100 of FIG. 1) and an uphole part 1201 performed by one or more controllers (e.g., 1500 of FIG. 15). However, other embodiments may incorporate one or more of the uphole processes into the downhole tool.

The process begins, in block 1210, with the acquisition of formation resistivity data using a downhole tool. For example, the tool of FIG. 1 having four triads, two axial arrays, and operating at multiple frequencies may be used. In other examples, a different downhole tool may be used. The downhole tool may receive control information 1211 to control the tool's acquisition of the logging data.

The acquired formation resistivity data is input to a pre-processing block (block 1212) that may perform any processing needed prior to the determination of the formation properties. For example, this processing may access a library of data, in block 1214, that comprises calibration and temperature correction data. The library 1214 may provide the data used in block 1212 to perform any calibration and/or temperature correction of the acquired data, depth alignment, data quality evaluation, and/or filtering and horn reductions. These preprocessing steps are for purposes of illustration only as other steps may be performed or a subset of the disclosed pre-processing steps may be performed.

In block 1218, the pre-processed data is input to an inversion process to determine geological formation properties (e.g., horizontal resistivity (Rₕ), vertical resistivity (Rᵥ), formation boundary layer dip angle, dip azimuth) as discussed previously with reference to FIG. 2. For example an MCI RID inversion may be used using data from an MCI library 1216. These properties are output in block 1233.

In block 1222, the resulting formation properties are input to a borehole correction process (e.g., MCI BHC) to remove the borehole effect. This block 1222 may also access the MCI library 1216 for data.

The borehole corrected data from block 1222 is input to the MCI dip-effect correction block 1100 and the post processing block 1226. As described previously with reference to FIG. 11, the MCI dip-effect correction block 1100 provides dip-effect corrected BHC log data (e.g., XX, YY, ZZ) to block 1231. The post processing block 1226 may use an inversion (e.g., zero dimension, V1D) to generate the Rₕ, Rᵥ, boundary layer dip angle, and dip azimuth angle in block 1232.

The MCI dip-effect corrected data from block 1100 is also input to a ZZ-array processing block 1224. The ZZ-array processing block 1224 may use a pre-calculated ZZ-process library 1220 to provide skin-effect correction, 2D software focusing, and R1D inversion (or formation profiling) of the MCI dip-effect corrected data. The processing block 1224 outputs array compensated resistivity tool data (e.g., R90, R60, . . . , R10 logs with 1-ft, 2-ft, and 4-ft vertical resolutions) to block 1230.

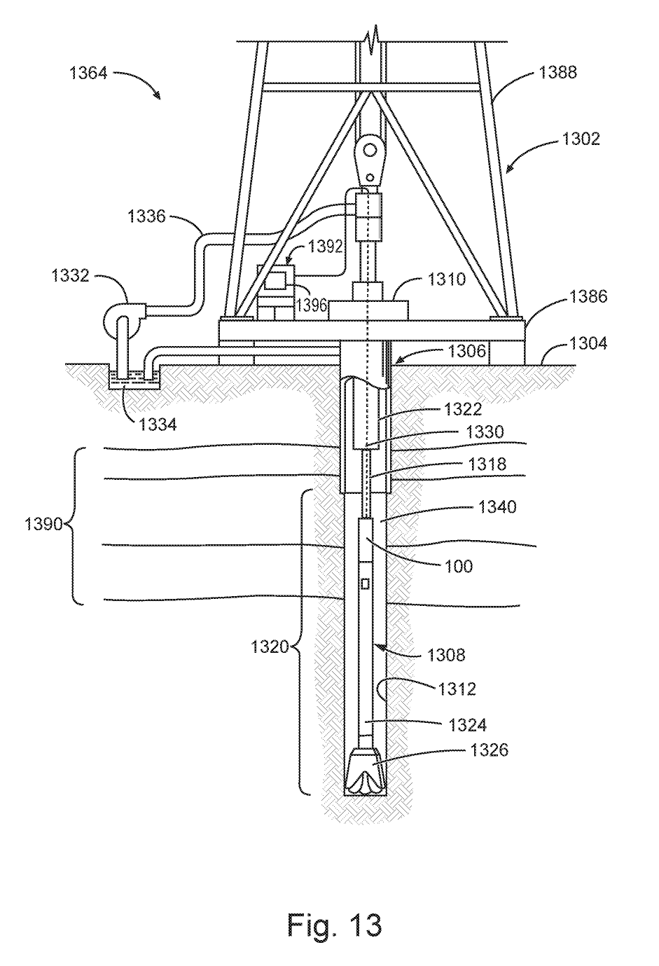

FIG. 13 is a diagram showing a drilling system, according to various embodiments. The system 1364 includes a drilling rig 1302 located at the surface 1304 of a well 1306. The drilling rig 1302 may provide support for a drillstring 1308. The drillstring 1308 may operate to penetrate the rotary table 1310 for drilling the borehole 1312 through the subsurface formations 1390. The drillstring 1308 may include a drill pipe 1318 and the bottom hole assembly (BHA) 1320 (e.g., drill string), perhaps located at the lower portion of the drill pipe 1318.

The BHA 1320 may include drill collars 1322, a downhole tool 1324, stabilizers, sensors, an RSS, a drill bit 1326, as well as other possible components. The drill bit 1326 may operate to create the borehole 1312 by penetrating the surface 1304 and the subsurface formations 1390. The BHA 1320 may further include a downhole tool including the multi-array, triaxial induction sensor tool 100 of FIG. 1 or some other type of downhole tool 100 to acquire downhole data for processing, as in FIGS. 11 and 12.

During drilling operations within the borehole 1312, the drillstring 1308 (perhaps including the drill pipe 1318 and the BHA 1320) may be rotated by the rotary table 1310. Although not shown, in addition to or alternatively, the BHA 1320 may also be rotated by a motor (e.g., a mud motor) that is located downhole. The drill collars 1322 may be used to add weight to the drill bit 1326. The drill collars 1322 may also operate to stiffen the BHA 1320, allowing the BHA 1320 to transfer the added weight to the drill bit 1326, and in turn, to assist the drill bit 1326 in penetrating the surface 1304 and subsurface formations 1390.

During drilling operations, a mud pump 1332 may pump drilling fluid (sometimes known by those of ordinary skill in the art as “drilling mud”) from a mud pit 1334 through a hose 1336 into the drill pipe 1318 and down to the drill bit 1326. The drilling fluid can flow out from the drill bit 1326 and be returned to the surface 1304 through an annular area 1340 between the drill pipe 1318 and the sides of the borehole 1312. The drilling fluid may then be returned to the mud pit 1334, where such fluid is filtered. In some examples, the drilling fluid can be used to cool the drill bit 1326, as well as to provide lubrication for the drill bit 1326 during drilling operations. Additionally, the drilling fluid may be used to remove subsurface formation cuttings created by operating the drill bit 1326.

A workstation 1392 including a controller 1396 may include modules comprising hardware circuitry, a processor, and/or memory circuits that may store software program modules and objects, and/or firmware, and combinations thereof that are configured to execute at least the methods of FIGS. 11 and 12. The workstation 1392 may also include modulators and demodulators for modulating and demodulating data transmitted downhole through the cable 1330 or telemetry received through the cable 1330 from the downhole environment. The workstation 1392 and controller 1396 are shown near the rig 1302 only for purposes of illustration as these components may be located at remote locations. The workstation 1392 may include the surface portion of the resistivity imaging tool system.

These implementations can include a machine-readable storage device having machine-executable instructions, such as a computer-readable storage device having computer-executable instructions. Further, a computer-readable storage device may be a physical device that stores data represented by a physical structure within the device. Such a physical device is a non-transitory device. Examples of a non-transitory computer-readable storage medium can include, but not be limited to, read only memory (ROM), random access memory (RAM), a magnetic disk storage device, an optical storage device, a flash memory, and other electronic, magnetic, and/or optical memory devices.

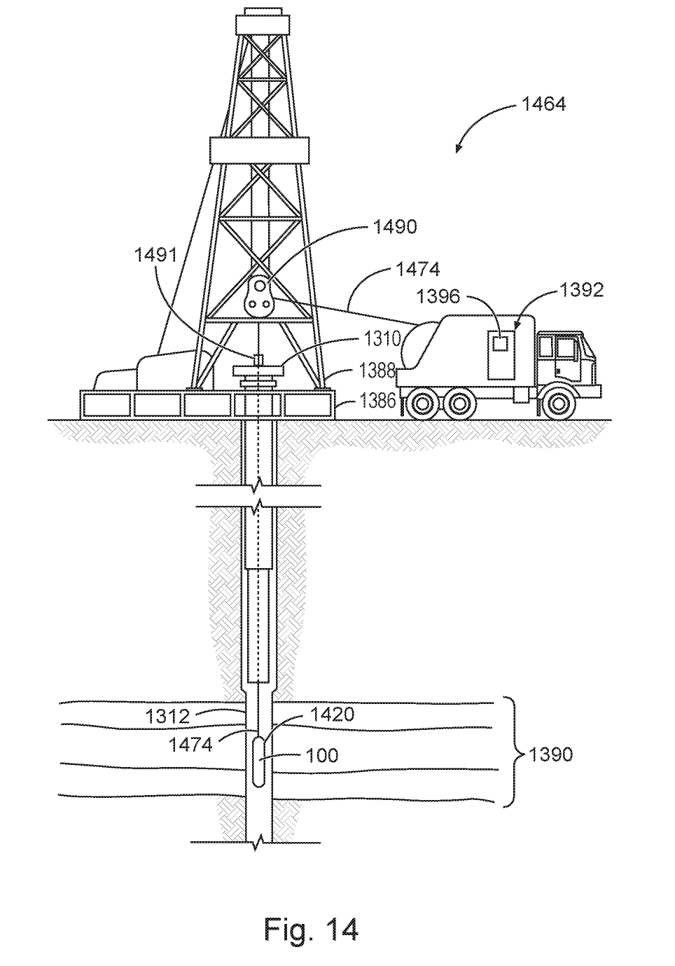

FIG. 14 is a diagram showing a wireline system 1464, according to various examples of the disclosure. The system 1464 may comprise at least one wireline logging tool body 1420, as part of a wireline logging operation in a borehole 1312, including the multi-array, triaxial induction sensor tool 100 described previously.

A drilling platform 1386 equipped with a derrick 1388 that supports a hoist 1490 can be seen. Drilling oil and gas wells is commonly carried out using a string of drill pipes connected together so as to form a drillstring that is lowered through a rotary table 1310 into the borehole 1312. Here it is assumed that the drillstring has been temporarily removed from the borehole 1312 to allow the wireline logging tool body 1420, such as a probe or sonde with the resistivity imaging tool 1300, to be lowered by wireline or logging cable 1474 (e.g., slickline cable) into the borehole 1312. Typically, the wireline logging tool body 1420 is lowered to the bottom of the region of interest and subsequently pulled upward at a substantially constant speed.

During the upward trip, at a series of depths, the tool with the multi-array, triaxial induction sensor tool 100 may be used to image the formation and perform formation parameter retrieval including formation resistivity data. The resulting formation resistivity data may be communicated to a surface logging facility (e.g., workstation 1392) for processing, analysis, and/or storage of the formation parameters. The workstation 1392 may have a controller 1396 that is able to execute any methods disclosed herein and to operate as part of a resistivity imaging tool system.

FIG. 15 is a block diagram of an example system 1500 operable to implement the activities of multiple methods, according to various examples of the disclosure. The system 1500 may include a tool housing 1506 having the downhole tool 100 (e.g., multi-array, triaxial induction sensor tool) disposed therein. The system 1500 may be implemented as shown in FIGS. 13 and 14 with reference to the workstation 1392 and controller 1396.

The system 1500 may include a controller 1520, a memory 1530, and a communications unit 1535. The memory 1530 may be structured to include a database. The controller 1520, the memory 1530, and the communications unit 1535 may be arranged to operate as a processing unit to control operation of the downhole tool 100 and execute any methods disclosed herein in order to determine the formation parameters.

The communications unit 1535 may include communications capability for communicating from downhole to the surface or from the surface to downhole. Such communications capability can include a telemetry system such as mud pulse telemetry. In another example, the communications unit 1535 may use combinations of wired communication technologies and wireless technologies.

The system 1500 may also include a bus 1537 that provides electrical conductivity among the components of the system 1500. The bus 1537 can include an address bus, a data bus, and a control bus, each independently configured or in an integrated format. The bus 1537 may be realized using a number of different communication mediums that allows for the distribution of components of the system 1500. The bus 1537 may include a network. Use of the bus 1537 may be regulated by the controller 1520.

The system 1500 may include display unit(s) 1560 as a distributed component on the surface of a wellbore, which may be used with instructions stored in the memory 1530 to implement a user interface to monitor the operation of the tool 1506 or components distributed within the system 1500. The user interface may be used to input parameter values for thresholds such that the system 1500 can operate autonomously substantially without user intervention in a variety of applications. The user interface may also provide for manual override and change of control of the system 1500 to a user. Such a user interface may be operated in conjunction with the communications unit 1535 and the bus 1537.

These implementations can include a machine-readable storage device having machine-executable instructions, such as a computer-readable storage device having computer-executable instructions. Further, a computer-readable storage device may be a physical device that stores data represented by a physical structure within the device. Such a physical device is a non-transitory device. Examples of machine-readable storage devices can include, but are not limited to, read only memory (ROM), random access memory (RAM), a magnetic disk storage device, an optical storage device, a flash memory, and other electronic, magnetic, and/or optical memory devices.

Many embodiments may be realized. Several examples will now be described.

Example 1 is a method comprising: measuring geological formation resistivity to generate formation resistivity data; performing a borehole correction (BHC) on the formation resistivity data to generate BHC log data; selecting a forward model based on the formation resistivity data; determining a dip-effect on the BHC log data based on the selected forward model; and generating dip-effect corrected BHC log data based on removal of the dip-effect from the BHC log data.

In Example 2, the subject matter of Example 1 can optionally include transmitting electromagnetic signals from a triaxial transmitter having coils aligned along x, y, and z axes; receiving electromagnetic signals from the geological formation in response to the transmitted electromagnetic signals, wherein a triaxial receiver is configured to receive the electromagnetic signals along the x, y, or z axes; and determining the formation resistivity data in response to the received electromagnetic signals wherein Rx represents the resistivity along the x-axis, Ry represents the resistivity along the y-axis, and Rz represents the resistivity along the z-axis in the formation principal coordinate system.

In Example 3, the subject matter of Examples 1-2 can optionally include: selecting a first model when Rx=Ry=Rz; selecting a second model when Rx=Ry≠Rz; and selecting a third model when Rx≠Ry≠Rz.

In Example 4, the subject matter of Examples 1-3 can optionally include wherein the first model comprises an isotropic model.

In Example 5, the subject matter of Examples 1-4 can optionally include wherein the second model comprises a transversely isotropic model.

In Example 6, the subject matter of Examples 1-5 can optionally include wherein the third model comprises a biaxial anisotropic model.

In Example 7, the subject matter of Examples 1-6 can optionally include wherein generating dip-effect corrected BHC log data based on the dip-effect comprises subtracting BHC log data from a deviated well having dip-effect from BHC log data of a vertical well without dip-effect.

In Example 8, the subject matter of Examples 1-7 can optionally include determining a formation layer boundary dip angle based on the formation resistivity data.

In Example 9, the subject matter of Examples 1-8 can optionally include wherein measuring the geological formation resistivity comprises measuring vertical resistivity, horizontal resistivity, and anisotropy dip angles for each formation region.

Example 10 is a non-transitory computer readable medium that stores instructions for execution by processing circuitry to perform operations to correct borehole corrected (BHC) log data for dip-effect, the operations: select a forward model from a plurality of forward models based on formation resistivity data; determine a dip-effect on the BHC log data based on the selected forward model; and generate dip-effect corrected BHC log data based on removal of the dip-effect from the BHC log data.

In Example 11, the subject matter of Example 10 can optionally include wherein the operations further select the forward model from one of an isotropic model, a transversely isotropic model, or a biaxial anisotropic model.

In Example 12, the subject matter of Examples 10-11 can optionally acquire the formation resistivity data, and perform a borehole correction (BHC) on the formation resistivity data to generate BHC log data.

In Example 13, the subject matter of Examples 10-12 can optionally include wherein the operations to acquire the formation resistivity data comprise a multi-triaxial induction sensor tool transmitting electromagnetic signals into the formation and receiving resulting electromagnetic signals from the formation.

In Example 14, the subject matter of Examples 10-13 can optionally include wherein the BHC data comprises data where a borehole effect has been removed.

In Example 15, the subject matter of Examples 10-14 can optionally include wherein the operations further determine a formation layer boundary relative dip angle.

In Example 16, the subject matter of Examples 10-15 can optionally perform skin effect correction on the dip-effect corrected BHC ZZ log data; and perform 2D software focusing or RID inversion of the dip-effect corrected BHC ZZ log data.

Example 17 is a system comprising: a triaxial sensor comprising: transmit coils aligned along respective x, y, and z axes and configured to transmit electromagnetic signals into a geological formation along the x, y, and z axes; and receive coils aligned along the respective x, y, and z axes and configured to receive resulting electromagnetic signals from the geological formation in response to the transmitted electromagnetic signals, the received electromagnetic signals representative of formation resistivity data; and control circuitry coupled to the triaxial sensor, the control circuitry configured to determine horizontal resistivity, vertical resistivity, and formation layer boundary dip angle based on the formation resistivity data; correct the formation resistivity data to remove borehole effect and generate borehole corrected (BHC) data, select a forward model based on the formation resistivity data, determine a dip-effect on the BHC data based on the selected forward model, remove the dip-effect from the BHC data to generate dip-effect corrected BHC data.

In Example 18, the subject matter of Example 17 can optionally include wherein the control circuitry is further configured to select the forward model based on electromagnetic signals detected by each of the receive coils.

In Example 19, the subject matter of Examples 16-18 can optionally include wherein the electromagnetic signal detected by each respective receive coil is representative of a formation resistivity along the axis aligned with the respective receive coil.

In Example 20, the subject matter of Examples 16-19 can optionally include wherein the control circuitry is further configured to determine the dip effect based on a dip angle between multiple resistivity formation regions.

This disclosure is intended to cover any and all adaptations or variations of various embodiments. Combinations of the above embodiments, and other embodiments not specifically described herein, will be apparent to those of skill in the art upon reviewing the above description.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
measuring geological formation resistivity to generate formation resistivity data;
performing a borehole correction (BHC) on the formation resistivity data to generate BHC log data;
selecting a forward model based on the formation resistivity data;
determining a dip-effect on the BHC log data based on the selected forward model; and
generating dip-effect corrected BHC log data based on removal of the dip-effect from the BHC log data.

2. The method of claim 1, wherein measuring the geological formation resistivity comprises:
transmitting electromagnetic signals from a triaxial transmitter having coils aligned along x, y, and z axes;
receiving electromagnetic signals from the geological formation in response to the transmitted electromagnetic signals, wherein a triaxial receiver is configured to receive the electromagnetic signals along the x, y, or z axes; and
determining the formation resistivity data in response to the received electromagnetic signals wherein Rₓ represents the resistivity along the x-axis, R_{y} represents the resistivity along the y-axis, and R_{z} represents the resistivity along the z-axis in the formation principal coordinate system.

3. The method of claim 2, wherein selecting the forward model comprises:
selecting a first model when Rₓ=R_{y}=R_{z};
selecting a second model when Rₓ=R_{y}≠R_{z}; and
selecting a third model when Rₓ≠R_{y}≠R_{z}.

4. The method of claim 3, wherein the first model comprises an isotropic model.

5. The method of claim 3, wherein the second model comprises a transversely isotropic model.

6. The method of claim 3, wherein the third model comprises a biaxial anisotropic model.

7. The method of claim 1, wherein generating dip-effect corrected BHC log data based on the dip-effect comprises subtracting BHC log data from a deviated well having dip-effect from BHC log data of a vertical well without dip-effect.

8. The method of claim 1, further comprising determining a formation layer boundary dip angle based on the formation resistivity data.

9. The method of claim 1, wherein measuring the geological formation resistivity comprises measuring vertical resistivity, horizontal resistivity, and anisotropy dip angles for each formation region.

10. A non-transitory computer readable medium that stores instructions for execution by processing circuitry to perform operations to correct borehole corrected (BHC) log data for dip-effect, the operations:
select a forward model from a plurality of forward models based on formation resistivity data;
determine a dip-effect on the BHC log data based on the selected forward model; and
generate dip-effect corrected BHC log data based on removal of the dip-effect from the BHC log data.

11. The non-transitory computer readable medium of claim 10, wherein the operations further select the forward model from one of an isotropic model, a transversely isotropic model, or a biaxial anisotropic model.

12. The non-transitory computer readable medium of claim 10, the operations further:
acquire the formation resistivity data; and
perform a borehole correction (BHC) on the formation resistivity data to generate BHC log data.

13. The non-transitory computer readable medium of claim 12, wherein the operations to acquire the formation resistivity data comprise a multi-triaxial induction sensor tool transmitting electromagnetic signals into the formation and receiving resulting electromagnetic signals from the formation.

14. The non-transitory computer readable medium of claim 12, wherein the BHC data comprises data where a borehole effect has been removed.

15. The non-transitory computer readable medium of claim 10, wherein the operations further determine a formation layer boundary relative dip angle.

16. The non-transitory computer readable medium of claim 10, wherein the operations further:
perform skin effect correction on the dip-effect corrected BHC ZZ log data; and
perform 2D software focusing or RID inversion of the dip-effect corrected BHC ZZ log data.

17. A system comprising:
a triaxial sensor comprising:
transmit coils aligned along respective x, y, and z axes and configured to transmit electromagnetic signals into a geological formation along the x, y, and z axes; and
receive coils aligned along the respective x, y, and z axes and configured to receive resulting electromagnetic signals from the geological formation in response to the transmitted electromagnetic signals, the received electromagnetic signals representative of formation resistivity data; and
control circuitry coupled to the triaxial sensor, the control circuitry configured to determine horizontal resistivity, vertical resistivity, and formation layer boundary dip angle based on the formation resistivity data; correct the formation resistivity data to remove borehole effect and generate borehole corrected (BHC) data, select a forward model based on the formation resistivity data, determine a dip-effect on the BHC data based on the selected forward model, remove the dip-effect from the BHC data to generate dip-effect corrected BHC data.

18. The system of claim 17, wherein the control circuitry is further configured to select the forward model based on electromagnetic signals detected by each of the receive coils.

19. The system of claim 18, wherein the electromagnetic signal detected by each respective receive coil is representative of a formation resistivity along the axis aligned with the respective receive coil.

20. The system of claim 19, wherein the control circuitry is further configured to determine the dip effect based on a dip angle between multiple resistivity formation regions.
